(19) United States
(12) Patent Application Publication
(10) Pub. No.: US 2025/0072648 A1
(43) Pub. Date: Mar. 6, 2025

(54) ADDITIVE DELIVERY SYSTEMS AND CONTAINERS

(71) Applicant: Cirkul, Inc., Tampa, FL (US)

(72) Inventors: Garrett S. Waggoner, Tampa, FL (US); Andrew Gay, Tampa, FL (US); Christopher Jasperse, Pittsburg, KS (US)

(73) Assignee: Cirkul, Inc., Tampa, FL (US)

(21) Appl. No.: 18/950,271

(22) Filed: Nov. 18, 2024

Related U.S. Application Data
(63) Continuation of application No. 17/539,833, filed on Dec. 1, 2021.
Application No. 17/539,833 is a continuation of application No. 15/791,348, filed on Oct. 23, 2017, now Pat. No. 11,213,159.
Application No. 15/791,348 is a continuation of application No. 14/181,354, filed on Feb. 14, 2014, now Pat. No. 9,795,242.
(60) Provisional application No. 61/764,861, filed on Feb. 14, 2013.

(51) Int. Cl. A47J 31/00

(52) U.S. Cl. CPC A47J 31/005

(57) ABSTRACT

A compact filtering and additive delivery system which is readily adaptable to a portable container, such as a sports bottle, and receives a modular additive container for the metered delivery of additive, such as flavor concentrate, to a stream of base liquid as the base liquid is drawn or dispensed from the container. The modular additive container configuration on the delivery system allows a consumer/user to experience different additives, such as different flavors or supplement compositions, for a given supply of base liquid, such as water, stored in the container. The system may be readily used with off-the-shelf containers, such as disposable water bottles. An additive container configuration provides modular additive delivery system as described herein.

### CROSS-REFERENCE TO RELATED APPLICATIONS

This application is a continuation and claims the priority benefit of U.S. patent application Ser. No. 17/539,833, filed on Dec. 1, 2021. This application is a continuation and claims the priority benefit of U.S. patent application Ser. No. 15/791,348, filed on Oct. 23, 2017, which is a continuation and claims the priority benefit of U.S. patent application Ser. No. 14/181,354, filed on Feb. 14, 2014, of the same title, now U.S. Pat. No. 9,795,242, which claims the priority benefit of U.S. Provisional Patent Application Ser. No. 61/764,861, titled “BOTTLE WITH REMOVABLE FLAVOR CARTRIDGE IN WHICH FLAVOR CONCENTRATE MIXES WITH WATER AS USER DRINKS,” filed on Feb. 14, 2013. The disclosures and subject matter of all of the above-described applications is incorporated by reference herein in its entirety.

### BACKGROUND

### 1. Technical Field

The disclosure relates to dispensing and delivery systems for beverages and other products. More specifically, the disclosure relates to dispensing and delivery systems for providing an additive, such as flavoring or supplements, to a base liquid, such as water, as the base liquid is dispensed from a container. The disclosure also relates to containers for containing and storing an additive to be used in additive delivery systems.

### 2. Prior Art

The prior art includes various devices for providing additives to a base liquid. Such devices include pre-mix systems, such as those exemplified in U.S. Pat. No. 7,306,117, in which a predetermined amount of additive is dispensed into a base liquid within the container and mixed therewith prior to consumption.

Prior art systems also include additive delivery systems in which an additive is dispensed as a base fluid is dispensed from a container. Such delivery systems are exemplified by U.S. Pat. No. 8,230,777, which describes a dispensing system in which a base liquid flows through a supplement area containing solid supplements, and U.S. Pat. No. 8,413,844, which describes a water dispenser (pitcher) having a filter and an additive chamber in which the additive is dispensed as water is poured from the dispenser.

Such prior art systems, however, suffer from the drawbacks of requiring rather elaborate and relatively expensive dispensing systems and fail to combine filtration and additive delivery functionality in a manner that is readily adapted to portable, compact, portable containers, such as sports bottles. There is thus a need for additive delivery systems and additive containers that are readily adaptable to portable base liquid containers and which address the aforementioned and other needs in the art.

### SUMMARY OF THE INVENTION

One aspect of the invention provides a compact filtering and additive delivery system, which is readily adaptable to a portable container, such as a sports bottle. The additive delivery system provides filtration and additive delivery to a base liquid while maintaining a generally consistent flow direction of the base liquid. The additive delivery system may receive a modular additive container selected by the user and provides for the metered delivery of additive, such as flavor concentrate, to a stream of base liquid as the base liquid is drawn or dispensed from the bottle. The modular additive container configuration on the delivery system allows a consumer/user to experience different additives, such as different flavors or supplement compositions, for a given supply of base liquid, such as water, stored in the container.

Another aspect of the invention provides a compact filtering and additive delivery system that may be used with off-the-shelf containers, such as disposable water bottles.

Yet another aspect of the invention provides a container configuration that is suitable for a modular additive delivery system as described herein.

Yet another aspect of the invention provides for uniform mixing of additive to a base liquid as the mixture is consumed, as well as a substantially uni-directional flow of base liquid and mixed additive/base liquid composition from the container.

### BRIEF DESCRIPTION OF THE DRAWINGS

The above and other attendant advantages and features of the invention will be apparent from the following detailed description together with the accompanying drawings, in which like reference numerals represent like elements throughout. It will be understood that the description and embodiments are intended as illustrative examples and are not intended to be limiting to the scope of invention, which is set forth in the claims appended hereto.

FIG. 1 is an exploded isometric view of an additive delivery system, combined with a sports bottle and filtration system according to an aspect of the invention;

FIG. 2 is a detailed exploded isometric view of an additive delivery system according to an aspect of the invention;

FIG. 3 is a cross-sectional exploded view of the additive delivery system of FIG. 2;

FIG. 4 is an isometric view of an additive container according to an aspect of the invention;

FIG. 5 is a cross-sectional view of an assembled additive delivery system according to an aspect of the invention;

FIG. 6 is a cross-sectional view showing flow paths of an additive delivery system according to an aspect of the invention.

### DETAILED DESCRIPTION

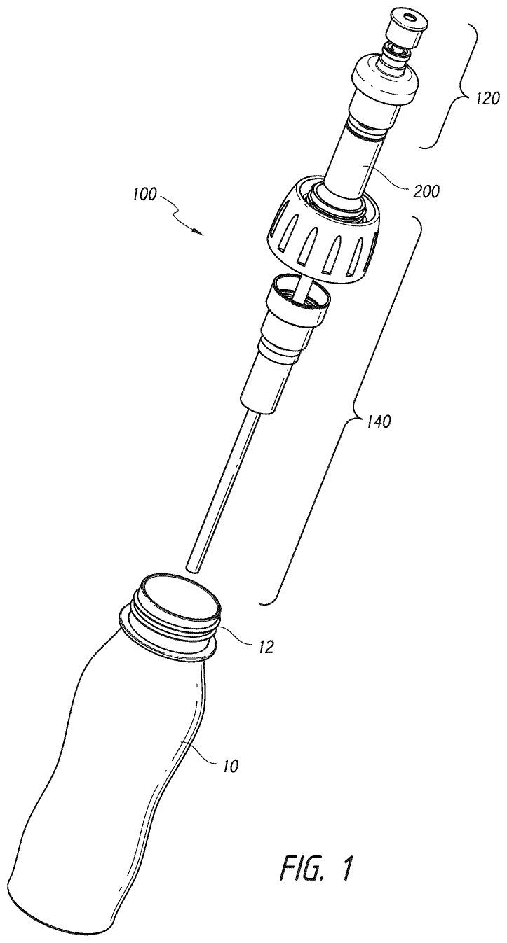

Referring to FIG. 1, an additive delivery system 100 according to an aspect of the invention includes an upper cap assembly 120 and a lower cap assembly 140, in combination with a sports bottle 10. Sports bottle 10 may include an inner volume for containing a base fluid, such as water, and a threaded mouth 12 for receiving and sealingly engaging the lower cap assembly 140. As will be described in more detail below, upper cap assembly 120 and lower cap assembly 140 cooperate to house a removable additive module 200.

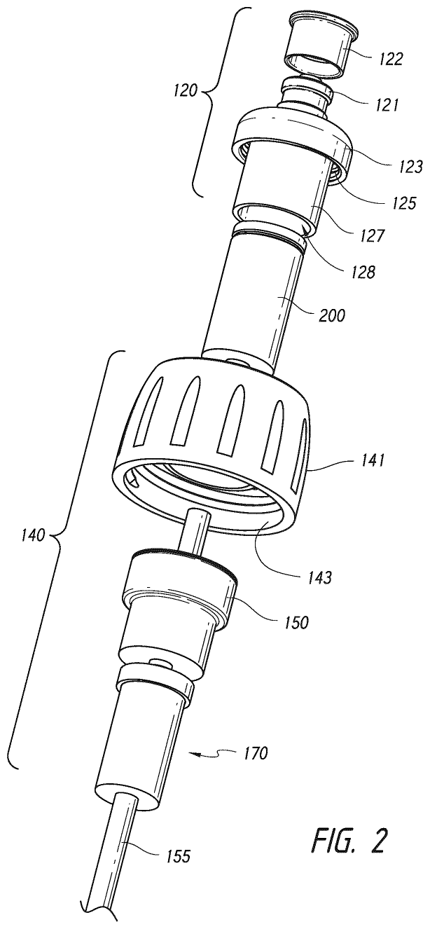

Referring additionally to FIG. 2, upper cap assembly 120 may include a spout 121 and a re-sealable spout closure 122 that cooperates therewith in a known manner. Upper cap assembly may also include a cap portion 123 having threaded interior wall 125 and an additive module enclosing wall 127 defining an additive module receiving space 128 for receiving additive module 200.

Lower cap assembly 140 may include a lower cap 141 having a container engaging female threaded portion 143 and an outer surface with gripping recesses formed therein. A lower additive module enclosure 150 cooperates with the lower cap 141 and upper cap assembly 120 to house and enclose additive module 200, as will be described below. Lower cap assembly 140 may include a filter assembly 170, which houses a filter for filtering the base liquid. A delivery tube 155 extends to the bottom of the base liquid container and provides for the travel of base liquid through the filter assembly 170, lower cap assembly 140, additive module 200 and, ultimately, to spout 121, as will be described in more detail below.

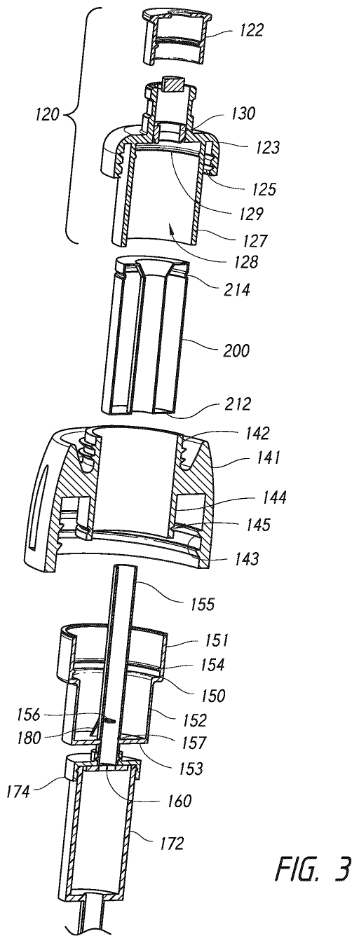

Referring additionally to the cross-sectional exploded view in FIG. 3, the additive module enclosing wall 127 of upper cap assembly 120 may include a retaining lip formed therein for engaging a retaining groove 214 on additive module 200. Lower cap assembly 140 may include an upper cap engaging male threaded portion 142 for engaging the female threads 125 on the upper cap 123. As will be recognized, this configuration allows easy removal and replacement of the additive module by the consumer as the upper cap assembly 120 may be unscrewed and removed with the additive module 200 remaining secured on the upper cap assembly 120 by way of the retaining lip 129 and retaining groove 214, which provide a snap fitting of the additive module 200 to the upper cap assembly. In addition, during removal of upper cap assembly 120, the lower cap 141 may remain secure on the container, preventing contamination or spillage of the base liquid.

According to an aspect of the invention, for safety and sanitary purposes, the additive module 200 may be provided with a transparent safety enclosure cap, which may engage the cap threads 125, and enclosed the additive module 200. In this configuration, the spout 121, spout closure 122 and safety enclosure cap (and thus the additive module, snap fit within the cap) may be sealed within a frangible thermoplastic membrane for consumer safety and product freshness. The transparent safety cap allows consumers to view the details/branding of the additive module before purchase, for example.

Lower cap 141 may also be provided with an annular wall 144 for engaging and fitting within a correspondingly-shaped upper annular wall 151 on the lower additive module enclosure assembly 150. Annular wall 144 may be provided with a retaining groove 145 for receiving a cooperating retaining lip 154 formed on the interior of upper annular wall 151 of the lower additive module enclosure assembly 150. A lower annular wall 152 and bottom wall 153 define a space for receiving a lower portion of the additive module 200. One or more additive module membrane piercing projections 180 may extend upward from the bottom wall 153 to pierce a frangible membrane 212.

Tube 155 extends upward through the lower module enclosure assembly 150 to permit flow of the base liquid. One or more metering ports 157 may be formed in the tube 155 near the bottom wall 153 to permit flow of additive concentrate from the interior of lower additive module enclosure 150 to the interior of tube 155 by venturi effect as the base liquid is drawn through tube 155. One or more mixing projections 156 may extend within the interior of tube 156 to induce turbulent flow and thereby mix the additive concentrate with the base fluid.

Filter assembly 170 may include a filter housing 172, which is snapped in place on a corresponding filter housing top 174 using a lip and groove retainer. A one-way check or flapper valve 176 formed of silicone rubber may be provided at the inlet of tube 155 from the interior of filter housing 172 to prevent backflow of the base fluid into the filter housing 172. An active carbon filter element (not shown in FIG. 3) may be provided on the interior of filter housing 172, as will be described in more detail below.

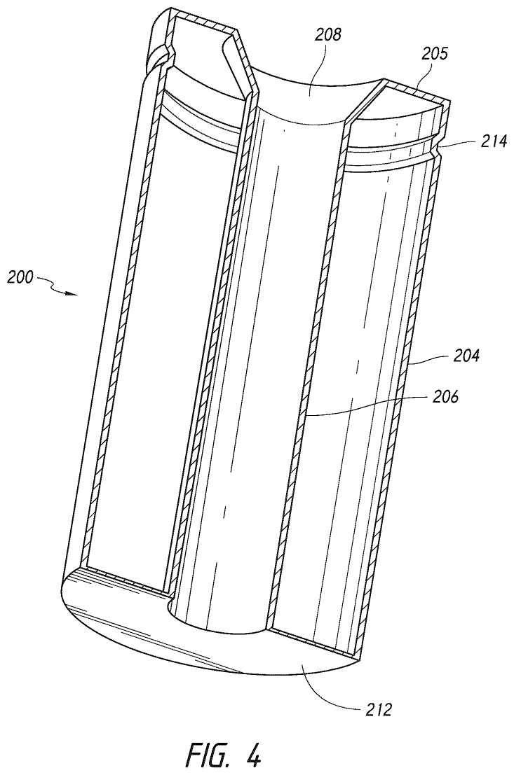

Referring additionally to FIG. 4, an additive module 200 according to aspects of the invention may include a generally cylindrical shape having an outer wall 204 provided with a retaining groove 214 formed therein and extending to a top wall 205 having a conical sealing surface 208. Conical surface 208 is adapted to sealingly engage a correspondingly shaped flexible seal 130 (FIG. 3), which may be made of silicone rubber or other material, and provided in upper cap assembly 120. An interior annular wall 206 defines, with upper wall 205 and outer wall 204, an interior additive containing space 210 for containing an additive, such as flavor or supplement concentrate. A frangible lower membrane 212, which may be made of foil or other material, forms a lower wall to contain and seal the additive within the module. As will be recognized, the module configuration provides for a consumer to carry and preserve a number of different additives for use with the additive delivery system and a single supply of base liquid in a container, such as a sports bottle.

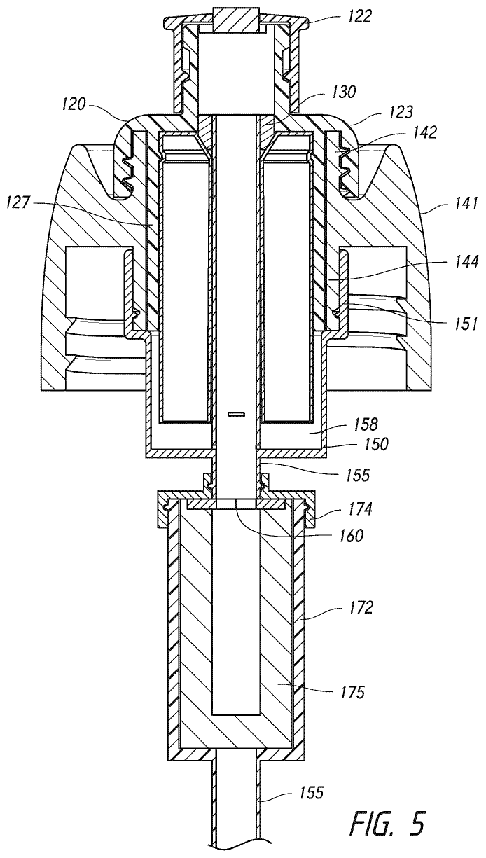

FIG. 5 illustrates a cross-section of an assembled additive delivery system according to an aspect of the invention. Spout closure 122 is shown in a closed position. Upper cap 123 is shown in an engaged position (i.e., screwed on) on the male threaded portion 142 of the lower cap 141, with the additive module enclosing wall 127 of the upper cap assembly 120 extending downward into the annular opening of the lower cap 141 and securing the additive module 200 therein. The upper annular wall 151 of lower additive enclosure assembly 150 engages the module holder receiving wall 144 of the lower cap assembly 140 via lip 154 and groove 145 to provide a snap fitting. Upper cap assembly 120, lower cap assembly 140 and lower additive module enclosure assembly thereby cooperate to provide a sealed containing space for the additive module 200.

Tube 155 extends upward within the inner tube formed by inner wall 206 of additive module 200. The conical sealing surface 208 is engaged by a correspondingly shaped silicone seal 130 secured within the upper cap assembly 120. In this position, the frangible membrane 212 of additive module 200 would be pierced or ruptured by piercing projections 180 (FIG. 3) and additive concentrate stored within additive module 200 would flow into the space 158. FIG. 5 also shows a cylindrical active carbon filter element 175 housed within the filter housing 172 to filter the base fluid.

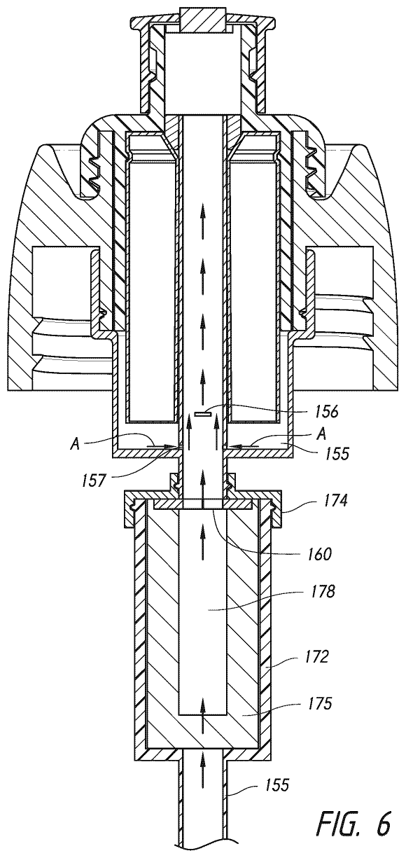

Referring additionally to FIG. 6, the base fluid is filtered as it flows from the lower portion of tube 155 to an interior space 178 defined by filter element 172, through the check valve 160, and upward into the upper portion of tube 155. Owing to a venturi effect, additive concentrate, represented by arrows “A” is drawn from the space 158, through metering ports 157 and into the interior of tube 155 where additive is mixed with the base fluid. Applicants have discovered that metering ports having a diameter of approximately 0.03 inches provide for suitable metering of additive liquid, while permitting the retention (non-leakage) of additive liquid from the additive module when flow of the base liquid is not occurring. As will be recognized, the diameter of metering ports may be varied depending on the viscosity of the additive liquid and other parameters such that flow occurs when needed but not when the base liquid is not flowing in the delivery tube. Mixing projection 156 enhances the mixing and uniform dilution of the additive within the base fluid. The mixed additive and base fluid composition continues up the tube 155 through the spout

As will be recognized, the flow of fluid through the system may be facilitated by suction provided by the consumer or by the squeezing of the container, which may be made of a suitably flexible material, or by both. As will also be recognized, flow from the base liquid container, through the filter assembly, delivery tube and additive module is substantially in a single, linear direction, without diversion, thereby providing for efficient flow of base liquid and mixed additive/base-liquid composition from the container and providing a configuration that is particularly adaptable to a sports bottle or other compact, portable, handheld container.

As will also be recognized, the additive delivery system may be used with standard, disposable water or beverage bottles through suitable adaptation of the fastening implements on the lower cap assembly.

As will also be recognized, suitable thermoplastic polymers may be used to form the various aforementioned elements, including polyethylene terepthalate (PET), polycarbonate, high-density polyethylene (HDPE) and others.

It should be understood that implementation of other variations and modifications of the invention in its various aspects may be readily apparent to those of ordinary skill in the art, and that the invention is not limited by the specific embodiments described herein. It is therefore contemplated to cover, by the present invention any and all modifications, variations or equivalents that fall within the spirit and scope of the claims that follow.

1-19. (canceled)

20. A drinking vessel assembly for adding an additive to a drinkable liquid, comprising:
a vessel for holding the drinkable liquid;
a lower cap assembly including a lower cap configured to engage the vessel and including an inner side and an outer side, and an additive module enclosure at the inner side of the lower cap defining a cavity accessible via an opening at the outer side of the lower cap;
an upper cap assembly including an upper cap configured to engage with a portion of the lower cap at the outer side that defines the opening;
an additive module having a reservoir for holding the additive to be mixed with the drinkable liquid, the additive module being attached to the upper cap and mountable in and removable from the cavity of the lower cap assembly via the opening; and
a delivery tube extending from the lower cap assembly and fluidly coupled to provide the drinkable liquid from a lower portion of the vessel to the cavity.

21. The assembly of claim 20, wherein the upper cap is configured to threadedly engage with the portion of the lower cap.

22. The assembly of claim 21, wherein the upper cap includes a spout configured to deliver mixed additive and drinkable liquid to a user.

23. The assembly of claim 22, further comprising a spout closure configured to open and close the spout.

24. The assembly of claim 20, wherein the upper cap assembly includes a wall to at least partially enclose the reservoir.

25. The assembly of claim 20, wherein the additive module is configured to be removed from the upper cap and replaced with a replacement additive module.

26. The assembly of claim 20, further comprising a one-way valve configured to prevent backflow of mixed drinkable liquid and additive into the delivery tube.

27. The assembly of claim 26, wherein the additive module includes a port to deliver additive from the reservoir to a flowpath for the drinkable liquid and the one-way valve is positioned upstream of the port.

28. The assembly of claim 20, comprising a flowpath for the drinkable liquid that extends from an inlet of the delivery tube to receive the drinkable liquid to an outlet of the upper cap to deliver mixed additive and drinkable liquid to a user for consumption, and a portion of the flowpath between the inlet and the outlet is fluidly coupled to the reservoir to receive additive from the reservoir for mixing with the drinkable liquid.

29. The assembly of claim 28, wherein the flowpath is configured to draw the additive from the reservoir and into the flowpath based on a venturi effect caused by flow of drinkable liquid in the flowpath.

30. The assembly of claim 20, wherein the lower cap is configured to close an opening to the vessel when engaged with the vessel.

31. The assembly of claim 20, wherein the delivery tube includes a proximal end that is attached to the lower cap assembly and a distal end portion that is positionable at a bottom of the vessel.

32. The assembly of claim 20, wherein the delivery tube is attached at a lower end of the additive module enclosure.

33. The assembly of claim 20, wherein the upper cap and additive module are configured to be removed from the cavity of the lower cap assembly while the lower cap assembly is engaged with the vessel.

34. The assembly of claim 20, wherein the upper cap and additive module are sealed within a frangible membrane.

35. A method of using a drinking vessel assembly, the method comprising:
providing a lower cap engaged with a vessel holding a drinkable liquid, the lower cap having a cavity to receive an additive module, the cavity being accessible via an opening at an upper side of the lower cap;
inserting the additive module through the opening and into the cavity of the lower cap, the additive module having a reservoir holding additive to be mixed with the drinkable liquid; and
engaging an upper cap, to which the additive module is attached, to the outer side of the lower cap to secure the upper cap and the additive module to the lower cap.

36. The method of claim 35, wherein inserting the additive module includes positioning a portion of the reservoir in the cavity at a lower side of the lower cap.

37. The method of claim 35, wherein inserting the additive module includes manipulating the upper cap and attached additive module to insert the additive module into the cavity.

38. The method of claim 37, wherein inserting the additive module includes inserting a wall that at least partially encloses the reservoir into the cavity.

39. The method of claim 38, wherein engaging the upper cap includes threadedly engaging the upper cap to the upper side of the lower cap.

40. The method of claim 35, further comprising:
delivering the drinkable liquid from the vessel into the cavity for mixing with additive from the reservoir; and
delivering mixed additive and drinkable liquid to a user via a spout on the upper cap.

41. The method of claim 40, wherein delivering the drinkable liquid includes delivering the drinkable liquid via a delivery tube attached to a lower end of the cavity.

42. The method of claim 41, wherein delivering the drinkable liquid includes delivering the drinkable liquid from a distal end of the delivery tube positioned near a bottom of the vessel to the cavity.

43. The method of claim 40, further comprising using a one-way valve to prevent backflow of mixed drinkable liquid and additive into the delivery tube.

44. The method of claim 40, further comprising providing additive from the reservoir to the drinkable liquid using a venturi effect caused by flow of the drinkable liquid along a flowpath.

45. A drinking vessel assembly for adding an additive to a drinkable liquid, comprising:
a lower cap assembly including:
a lower cap configured to engage a vessel containing the drinkable liquid and including an upper side and a lower side,
an additive module enclosure defining a cavity to receive an additive module having a reservoir for holding the additive to be mixed with the drinkable liquid, the cavity extending from an opening at the upper side of the lower cap to the lower side of the lower cap, and
a delivery tube having a proximal end attached to the lower end of the additive module enclosure and a distal end opposite the proximal end, the delivery tube configured to deliver the drinkable liquid from a bottom portion of the vessel to the cavity.

46. The assembly of claim 45, further comprising:
an upper cap assembly including an upper cap configured to engage with a portion of the lower cap at the outer side that defines the opening; and
the additive module attached to the upper cap and mountable in and removable from the cavity of the lower cap assembly via the opening.

47. The assembly of claim 45, further comprising the vessel for holding the drinkable liquid.
